(19) United States
(12) Patent Application Publication
(10) Pub. No.: US 2009/0140528 A1
(43) Pub. Date: Jun. 4, 2009

(54) Wind and Updraft Turbine

(75) Inventor: Barry R. Ireland, Moosomin (CA)

Correspondence Address: FULBRIGHT & JAWORSKI L.L.P, 2200 ROSS AVENUE, SUITE 2800, DALLAS, TX, 75201-2784, US

(73) Assignee: BRI Energy Solutions Limited, Moosomin (CA)

(21) Appl. No.: 12/334,333

(22) Filed: Dec. 12, 2008

Related U.S. Application Data
(63) Continuation-in-part of application No. 12/298,472.

(30) Foreign Application Priority Data
Apr. 20, 2007 (CA) PCT/CA2007/000665

(51) Int. Cl. F03D 9/00

(52) U.S. Cl. 290/55

(57) ABSTRACT

The invention relates to the field of electrical generation and more specifically to the use of a wind turbine for generating electricity. The invention provides a fully integrated vertical axis wind turbine (VAWT) which can be mounted on a cylindrical pole. Rotor blades are disposed on the outside of a permanent magnet generator integral to the VAWT, the rotor blades being coupled directly to a rotating, current inducing set of permanent magnets or rotor for rotation about a stationary, current generating stator. At least three rotor blades are used which are vertically offset from one another.

### CROSS-REFERENCE TO RELATED APPLICATIONS

This application is a continuation-in-part of U.S. Ser. No. 12/298,472 which is a national phase entry under 35 USC 371 of International Application PCT/CA2007/000665 filed Apr. 20, 2007, claiming the benefit of U.S. provisional applications U.S. 60/869,860 filed Dec. 13, 2006 and U.S. 60/794,094 filed Apr. 24, 2006, the disclosures of which are incorporated herein by reference.

### TECHNICAL FIELD

The invention relates to the field of electrical generation and more specifically to the use of a wind turbine for generating electricity.

### BACKGROUND OF THE INVENTION

As those skilled in the art are aware, the availability of energy sources such as coal, oil and natural gas are limited which has resulted in escalating costs for such fuels. This rising cost is significant for residential users and even more significant for commercial users such as manufacturers where such costs could mean the difference between continued operation and bankruptcy.

As a result of such rising costs, there have been intensive initiatives to develop alternate energy sources, a sub-group of which includes renewable energy sources which capture their energy from ongoing natural processes such as sunshine, wind, flowing water, biological processes and geothermal heat flows. Renewable energy sources may be used directly or used to create other more convenient forms of energy. An example of direct use would include geothermal, while an example of indirect use would include a wind turbine used to generate electricity.

A wind turbine may be attached to an electrical generator to produce electricity. Wind turbines can be separated into two general types based on the axis (either horizontal or vertical) about which the turbine rotates. With a vertical axis wind turbine (VAWT), the generator is typically placed at the bottom of the tower on which the VAWT is mounted so that the tower doesn't need to support it. As shown in FIG. 1, VAWT 100 mounted to tower 110 is connected to generator 120 which may store the electricity produced, for example, in capacitor or battery 130 or distribute it directly to residential or commercial end user 140. Smaller VAWTs have been designed for residential and commercial use such as the 2.5 kW VAWT offered by Cleanfield Energy Corp. of Mississauga, Ontario, Canada. As shown in FIG. 2, this proprietary VAWT 200 features three narrow, three-metre vertical blades 210 that are attached to central shaft 220. Central shaft 220 connects directly to a rotor (not shown) of generator 230. Generator 230 is a low-speed direct-connected permanent magnet synchronous generator that converts the rotational mechanical energy of the rotor into electric energy. Wind moves blades 210 and central shaft 220 is rotated thereby serving as a drive shaft for the rotor. Operating in conjunction with a stator (not shown) integral to generator 230, electricity is produced.

VAWT 200 of FIG. 2 is capable of adequately producing electricity, but it is limited by design. More specifically, central shaft 220 carries blades 210. If central shaft 200 rotates too quickly due, for example, to excessive wind speed, the increased twist or torque may cause central shaft 220 to break or bearings (not shown) between to the shaft and the generator to come apart. In other words, VAWT 200 must operate at low blade speeds which in turns results in lower amounts of electricity being generated. Additionally, even if VAWT 200 could handle higher blade speeds, the actual configuration of the blades is limiting. Since blades 210 all operate on the same horizontal plane, blades 210 cannot physically disperse the air fast enough to generate higher blades speeds.

A VAWT which is able to take advantage of blade configurations which maximize blade rotation and thus the power generated would be desirable. Further, a VAWT which can be readily mounted in a variety of environments would allow its use in a wide variety of applications.

### BRIEF SUMMARY OF THE INVENTION

The present invention seeks to overcome the deficiencies of the prior art by providing a fully integrated vertical axis wind turbine (VAWT) which can be mounted on a cylindrical pole. Rotor blades are disposed on the outside of a permanent magnet generator integral to the VAWT of the present invention, the rotor blades being coupled directly to a rotating, current inducing set of permanent magnets or rotor for rotation about a stationary, current generating stator. At least three rotor blades are used which are vertically offset from one another.

Certain exemplary embodiments may provide a wind turbine mountable at or near an upper portion of a stationary cylindrical pole, the wind and updraft turbine comprising: a current inducing rotor comprising a current inducing set of permanent magnets rotatable about the upper portion of the cylindrical pole, about an axis at least substantially in line with a main axis of the cylindrical pole; a stationary, current generating stator comprising at least one wound coil about which the current inducing rotor rotates, wherein the current inducing rotor generates a magnetic field which passes in close proximity to the at least one wound coil; and at least three wind-engaging rotor blades extending vertically from an outer casing associated with the current inducing rotor, wherein each of the at least three wind-engaging blades are movable upon application thereto of a prevailing wind, and wherein the at least three wind engaging rotor blades are vertically offset from one another, and wherein each of the at least three wind engaging rotor blades comprises a trough-shaped, vertical, wind engaging portion extending from an arm attached to the outer casing associated with said current inducing rotor.

In one aspect, the current inducing rotor comprises a circular array of permanent magnets, the current generating stator comprises a circular array of wound coils, the circular array of wound coils extends around a circumference of the cylindrical pole and is rigidly attached thereto, and the circular array of permanent magnets extends around a circumference of the stator and is rotatably attached thereto, thereby avoiding a torsional force on the cylindrical pole when the at least three wind-engaging rotor blades attached to the outer casing associated with the current inducing rotor begin to move.

In another aspect, the current generating stator comprises a horizontally disposed circular array of wound coils, the current inducing rotor comprises a horizontally circular array of permanent magnets positioned above, and in close proximity to the circular array of wound coils, the circular array of wound coils extends around a circumference of the cylindrical pole and is rigidly attached thereto, and the circular array of permanent magnets extends around a circumference of the cylindrical pole and is rotatably attached thereto, thereby avoiding a torsional force on the cylindrical pole when the at least three wind-engaging rotor blades attached to the outer casing associated with said current inducing rotor begin to move.

Alternately, a plurality of the horizontally disposed circular arrays of wound coils are layered above and in close proximity to a plurality of the horizontally disposed circular arrays of permanent magnets and the at least three rotor blades are removably attached to a top surface of an uppermost circular array of permanent magnets.

The advantages of the invention are now readily apparent. The compact VAWT of the present invention can efficiently generate electricity through its integrated design and ability to be mounted on any available cylindrical pole. The VAWT may be mounted on existing infrastructure e.g. a cylindrical pole extending from a residential building or a communications tower. The compact integrated VAWT allows wind turbine owners to be at least partially self-sufficient for their supply of electricity, producing and storing electricity locally instead of relying on power produced by large, remote commercial stand alone generators.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The invention will now be described in relation to the following drawings in which:

FIG. 1 depicts a prior art electricity generation system using a vertical axis wind turbine;

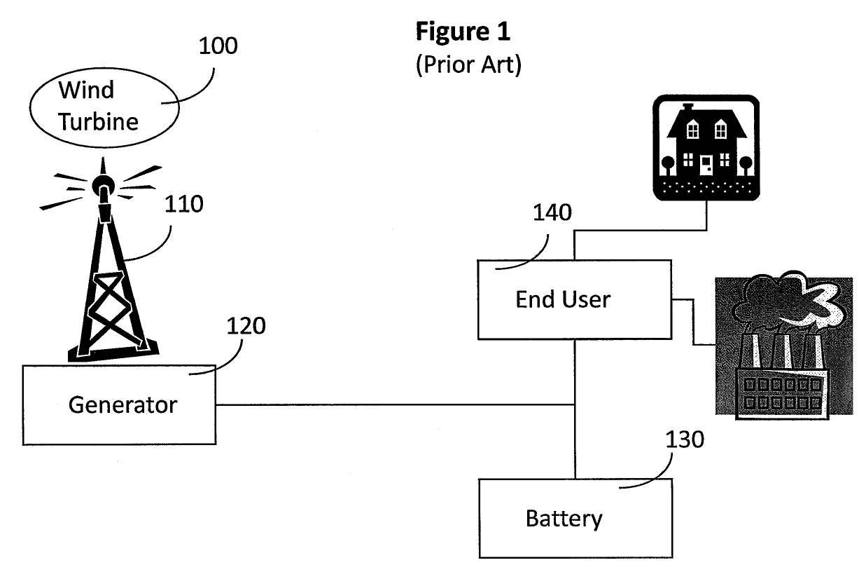

FIG. 2 depicts a prior art vertical axis wind turbine which may be used in the system of FIG. 1;

FIG. 3 depicts a functional block diagram of an alternator;

FIG. 4(a) depicts a cylindrical pole housing a VAWT in accordance with a first embodiment of the present invention mounted thereon;

FIG. 4(b) depicts in greater detail the stator of the first embodiment of FIG. 4(a);

FIG. 4(c) depicts in greater detail the rotor of the first embodiment of FIG. 4(a);

FIG. 5(a) depicts a cylindrical pole housing a VAWT in accordance with a second embodiment of the present invention mounted thereon;

FIG. 5(b) depicts in greater detail the stator of the second embodiment of FIG. 5(a);

FIG. 5(c) depicts in greater detail the rotor of the second embodiment of FIG. 5(a);

FIG. 5(d) depicts the stator and rotor of FIGS. 5(b) and 5(c) in assembled form with the cover removed;

FIGS. 6(a) to 6(e) depict a blade used in both the first and second embodiments;

FIGS. 7(a) and 7(b) depict the present invention mounted to a communications tower.

### DETAILED DESCRIPTION OF THE INVENTION

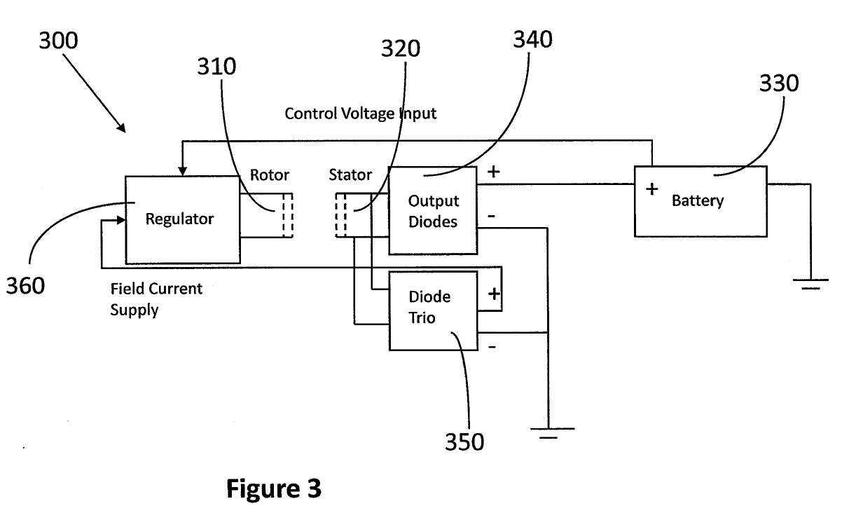

As understood by those in the art, in a VAWT the electrical generator produces electrical energy from a mechanical energy source i.e. the rotation of the blades. An alternator is a generator that converts mechanical energy to alternating electrical current. When the magnetic field around a conductor changes, current or energy is induced in the conductor. Referring to FIG. 3, in a typical alternator (labeled generally as 300), a rotating magnet or rotor 310 turns within stator 320, a stationary set of conductors wound in coils on an iron core. When rotor 310 rotates, its magnetic field cuts across the conductors (or windings) of stator 320, generating electrical current or energy, as the mechanical input causes the rotor to turn. The magnetic field of rotor 310 may be produced by a rotor winding energized with direct current (i.e. a field current) through slip rings and brushes (not shown). If a direct current output is desired (e.g. to charge a battery 330), the alternating current voltage is converted by output diodes 340 into pulsating direct current voltage. Additionally, to regulate the field current delivered to rotor 310, diode trio 350 may be used to provide field current to a regulator 360 with a control voltage input from the battery being used to determine if more or less field current is required to increase or decrease the magnetic field strength of rotor 310.

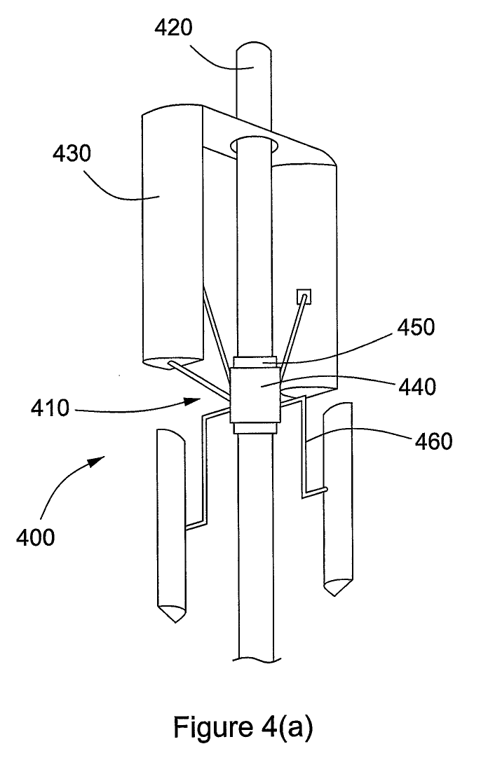

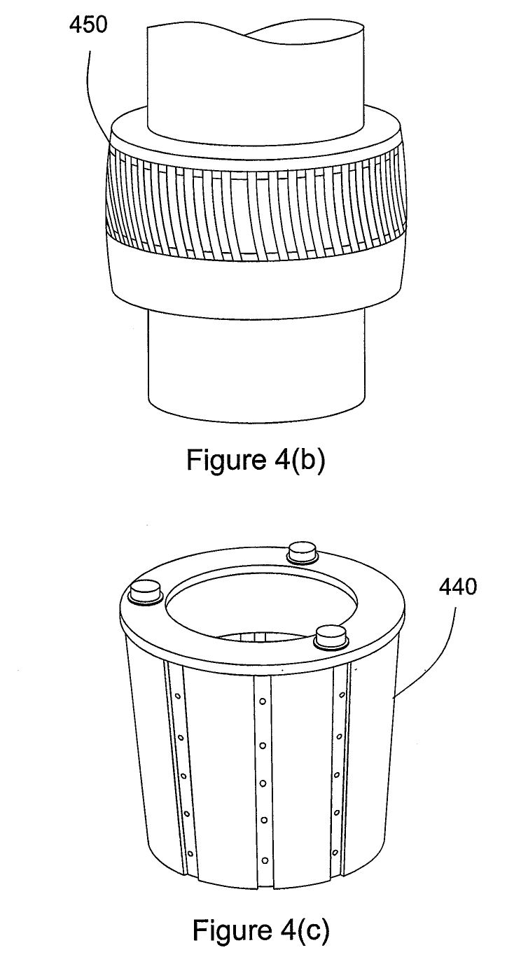

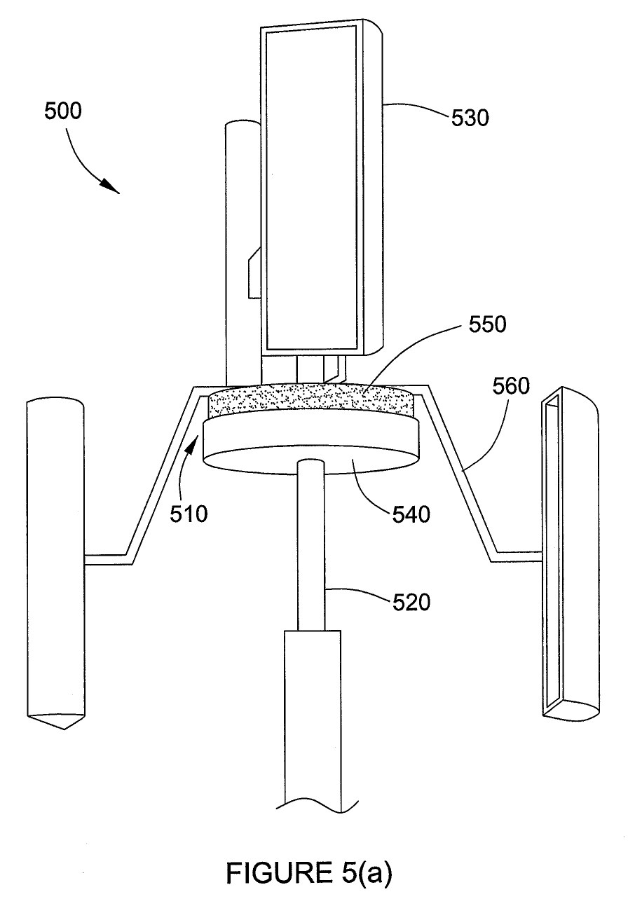

FIGS. 4(a) to 4(c) depict a first embodiment 400 of the present invention. In this configuration, a ring-shaped permanent magnet generator 410 is integrated with cylindrical pole 420. In this embodiment, vertical rotor blades 430 are coupled directly to an outer casing associated with a rotating, current inducing set of permanent magnets or rotor 440 (see FIG. 4(c) for greater detail) for rotation about a stationary, current generating stator 450 (see FIG. 4(b) for greater detail) which is rigidly affixed to cylindrical pole 420. The outer casing of rotor 440 includes bearings (not shown) positioned at the top and bottom which allow rotor 440 to rotate smoothly about stator 450 (i.e. cylindrical pole 420 does not rotate). Similar to a traditional generator, the permanent magnets produce a magnetic field. However, rotor 440 rotates around stator 450. When the magnetic field of rotor 440 cuts through the conductors of stator 450, a voltage is induced in the conductors. Stator 450 may be wound for single phase or three phase alternating current generation as is well known in the art. Current produced by generator 410 can be used immediately in a device requiring electricity or stored in a battery pack (not shown).

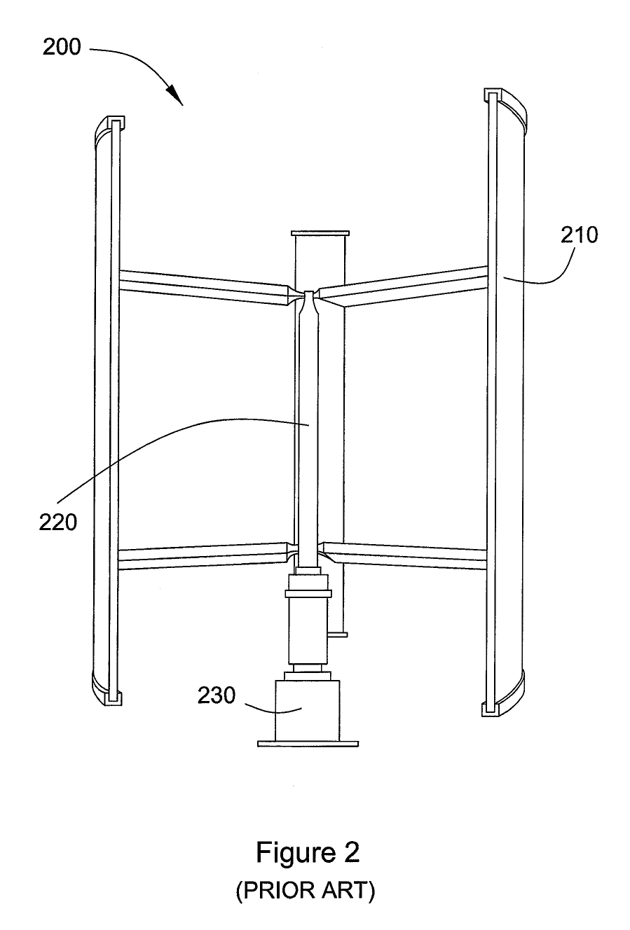

The key advantage of this configuration is that the need for linkages and/or a driveshaft between rotor blades 430 and generator 410 is avoided and blades 430 do not need to be attached to cylindrical pole 420 (as discussed in relation to FIG. 2 of the prior art). As a result, there is no rotational torque on cylindrical pole 420 thereby eliminating the possibility that cylindrical pole 420 will shear off, one of the disadvantages discussed in relation to the prior art. Further, because rotor 440 with attached rotor blades 430 rotates around stator 450, there are only two long life bearings which are subject to wear. Due to the limited number of moving parts lower vibration and noise levels are achieved. As will be appreciated by those in the art, ring-shaped permanent magnet generator 410 can be retrofitted to encircle any cylinder i.e. it can make use of existing infrastructure, thereby making it extremely versatile for a wide variety of commercial or residential applications.

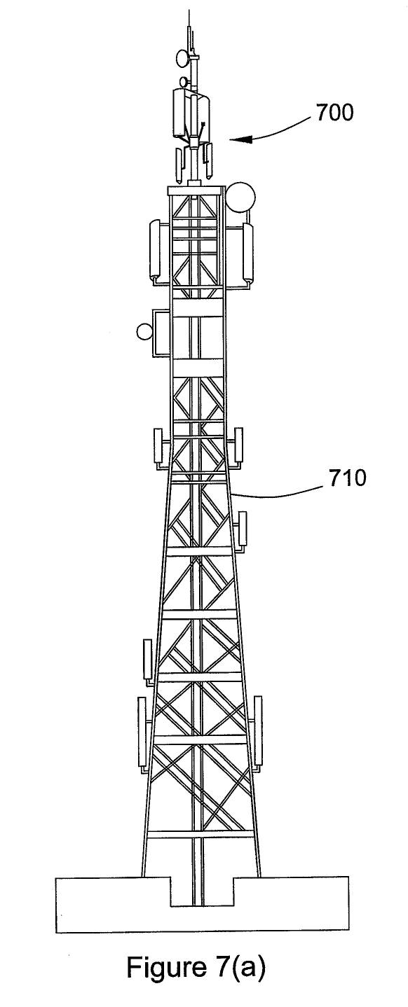

FIGS. 4(b) and 4(c) depict in greater detail the rotor and stator of the embodiments shown in FIG. 4(a). More specifically, the current generating stator 450 is depicted in FIG. 4(b), while the current inducing set of permanent magnets or rotor 440 is depicted in FIG. 4(c). As will be discussed in more detail below, FIGS. 6(a) to 6(e) depict in greater detail rotor blades 430 which are removably attached to rotor 440 with arms 460.

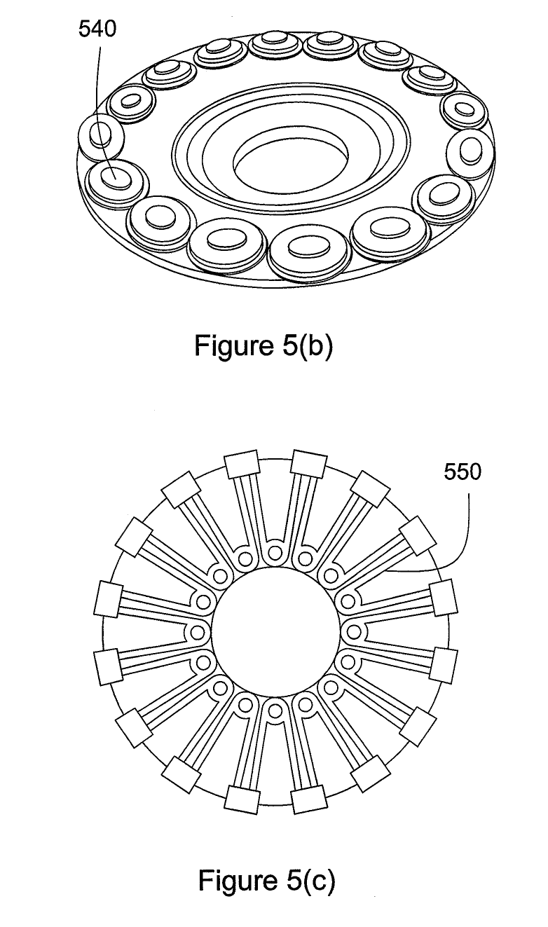

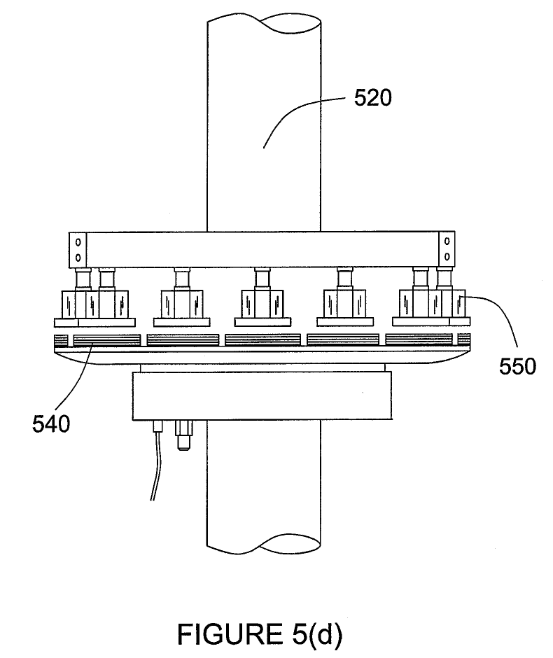

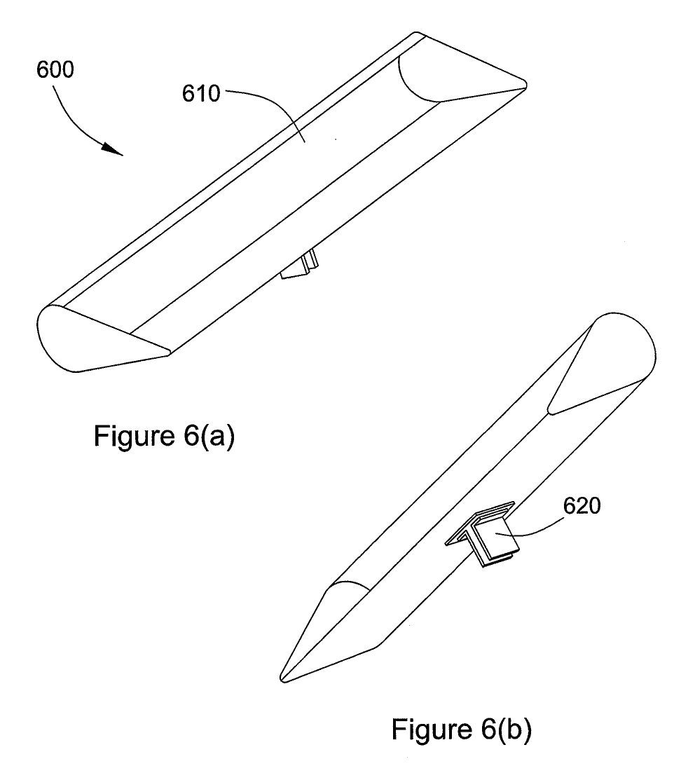

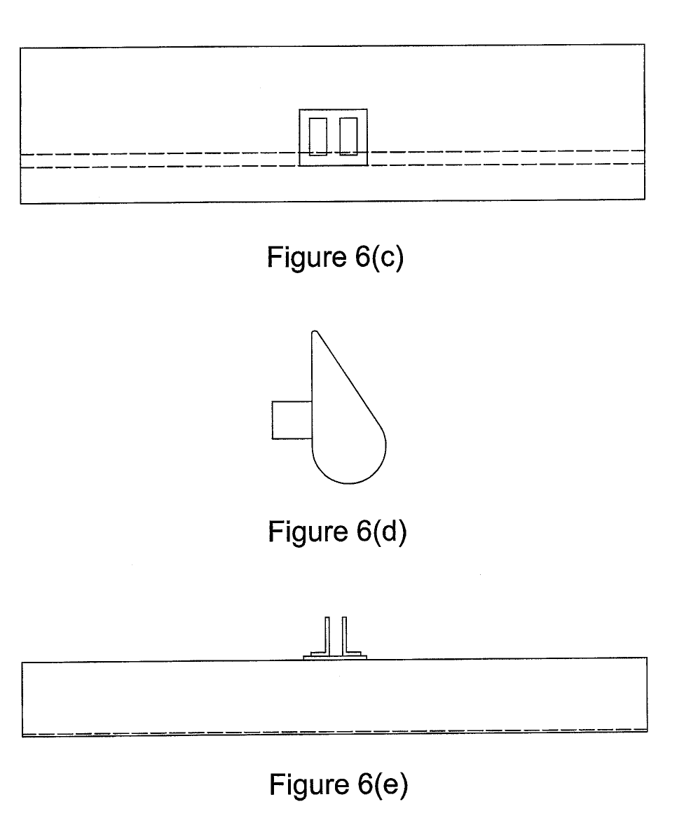

FIGS. 5(a) to 5(c) depict a variation of the embodiment of FIGS. 4(a) to 4(c). In this embodiment 500, the permanent magnet generator 510 is comprised of a horizontally disposed circular array of wound coils 540 (see FIG. 5(b) for a detailed view) and a horizontally disposed circular array of permanent magnets 550 (see FIG. 5(c) for a detailed view). The circular array of wound coils 540 is rigidly fixed to cylindrical pole 520, while the circular array of permanent magnets 550 is positioned above, and in close proximity to, wound coils 540. Vertical rotor blades 530 are coupled directly to an outer casing associated with the top surface of the circular array of permanent magnets 550. The circular array of permanent magnets 550 rotate about cylindrical pole 520 on bearings (not shown). FIG. 5(d) depicts the circular array of wound coils 540 and circular array of permanent magnets in assembled form with the outer casing removed. As highlighted in FIG. 5(d), the circular array of wound coils 540 is horizontally disposed and affixed to cylindrical pole 520. The circular array of permanent magnets 550 are also horizontally disposed for rotation about cylindrical pole 520 in close proximity to the circular array of wound coils 540. The circular array of permanent magnets 550 are magnetically coupled to the circular array of wound coils 540. More specifically, when the magnetic field associated with the circular array of permanent magnets 550 cuts across the windings of the circular array of wound coils 540, an electrical current is generated which can be used immediately in a device requiring electricity or stored in a battery pack (not shown).

Similar to the embodiments of FIGS. 4(a) to (c), the key advantage of the configuration of FIG. (5(a) is that the need for linkages and/or a driveshaft between rotor blades 530 and generator 510 is avoided and blades 530 do not need to be attached to cylindrical pole 520. As a result, there is no rotational torque on cylindrical pole 520 thereby eliminating the possibility that cylindrical pole 520 will shear off.

FIGS. 5(b) and 5(c) depict in greater detail the circular array of wound coils 540 and the circular array of permanent magnets 550 integral to the embodiments shown in FIG. 5(a). More specifically, the circular array of wound coils 540 is depicted in FIG. 5(b), while the circular array of permanent magnets 550 is depicted in FIG. 5(c). As will be discussed in more detail below, FIGS. 6(a) to 6(e) depict in greater detail rotor blades 530 which are removably attached to the top surface of the circular array of permanent magnets 550 with arms 560.

A variation in the aforementioned embodiment comprises rows of horizontally disposed circular arrays of wound coils 540 which are layered with and in close proximity to rows of horizontally disposed circular arrays of permanent magnets 550. Similar to the embodiment of FIG. 5(a), the horizontally disposed circular arrays of wound coils 440 are attached to cylindrical pole 520. Rotor blades 530 are removably attached to the top surface of the uppermost circular array of permanent magnets 550 and the circular arrays of permanent magnets 550 are coupled together. Upon movement of rotor blades 530, the horizontally disposed circular arrays of permanent magnets 550 rotate together.

FIGS. 6(a) to 6(e) depict the configuration of rotor blades 600 reflecting rotor blades 430, 530 shown in the embodiments of FIGS. 4(a) and 5(a). FIGS. 6(a) and 6(b) are perspective views which highlight the trough-like feature 610 which is designed to catch the wind and maximize rotation of the rotor. Rotor blades 600 may span ten feet in height and cover more than 5 feet in diameter but they are not meant to be limited in this regard. As highlighted in FIG. 6(b), rotor blade 600 includes a bracket 620 for removable attachment to generator 410, 510 using arms 460, 560.

Notably, whether associated with the embodiment of FIG. 4(a) or 5(a), rotor blades 600 are vertically offset from one another. In the presence of a horizontal wind, with the rotor blades 600 configured as depicted in FIG. 4(a) or 5(a), the rotational speed of rotor blades 600 is greater than blades configured in a more traditional configuration i.e. the same horizontal plane. As those skilled in the art will appreciate, increased rotational speed translates directly to increased horsepower (hp) in generator 410, 510. As wind speed increases, the horsepower (hp) generated by generator 410, 510 increases with a multiplier effect e.g. if the wind speed doubles, more than eight times the power becomes available.

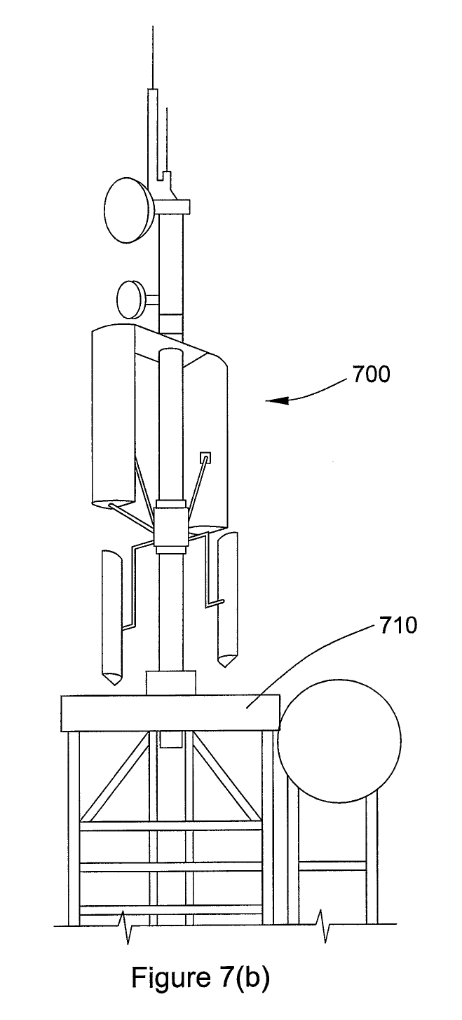

FIGS. 7(a) and 7(b) depict a typical installation of the embodiments of FIGS. 4(a) and 5(a). As previously discussed, the embodiments of FIGS. 4(a) and 5(a) can be retrofitted to any cylindrical pole in either an industrial and residential application. For example, it can fitted on any building from which a cylindrical pole can be extended, or, as depicted in FIGS. 7(a) and 7(b), wind turbine 700 can be mounted on the top end of a communications tower 710 such as a microwave tower used in a wireless network. The use of existing infrastructure to accommodate the present invention is a key advantage, along with the wind turbines efficient generation of electricity.

Although the present invention has been fully described by way of the examples with reference to the accompanying drawings, it is to be noted that various changes and modifications will be apparent to those skilled in the art. Therefore, unless such changes and modifications otherwise depart from the spirit and scope of the present invention, they should be construed as being included therein. For example, although the present invention may be preferably mounted on cylindrical pole 80, it could also be mounted on square tubing or the like which extends vertically.

What is claimed is:

1. A wind turbine mountable at or near an upper portion of a stationary cylindrical pole, said wind turbine comprising:
a current inducing rotor comprising a current inducing set of permanent magnets rotatable about said upper portion of said cylindrical pole, about an axis at least substantially in line with a main axis of said cylindrical pole;
a stationary, current generating stator comprising at least one wound coil about which said current inducing rotor rotates, wherein said current inducing rotor generates a magnetic field which passes in close proximity to said at least one wound coil; and
at least three wind-engaging rotor blades extending vertically from an outer casing associated with said current inducing rotor, wherein each of said at least three wind-engaging blades are movable upon application thereto of a prevailing wind, and wherein said at least three wind engaging rotor blades are vertically offset from one another, and wherein each of said at least three wind engaging rotor blades comprises a trough-shaped, vertical, wind engaging portion extending from an arm attached to said outer casing associated with said current inducing rotor,
wherein said current inducing rotor comprises a circular array of permanent magnets, and wherein said current generating stator comprises a circular array of wound coils, and wherein said circular array of permanent magnets extends around a circumference of said stator and is rotatably attached thereto, thereby avoiding a torsional force on said cylindrical pole when said at least three wind-engaging rotor blades attached to said outer casing associated with said current inducing rotor begin to move.

2. The wind turbine of claim 1, wherein said at least three wind-engaging rotor blades are removably mounted with rotational symmetry about said outer casing associated with said current inducing rotor.

3. The wind turbine of claim 2, wherein the number of wind-engaging rotor blades is four.

4. A method comprising:
providing a current inducing rotor comprising a current inducing set of permanent magnets rotatable about said upper portion of said cylindrical pole, about an axis at least substantially in line with a main axis of said cylindrical pole;
providing a stationary, current generating stator comprising at least one wound coil about which said current inducing rotor rotates, wherein said current inducing rotor generates a magnetic field which passes in close proximity to said at least one wound coil;
providing at least three wind-engaging rotor blades extending vertically from an outer casing associated with said current inducing rotor, wherein each of said at least three wind-engaging blades are movable upon application thereto of a prevailing wind, and wherein said at least three wind engaging rotor blades are vertically offset from one another, and wherein each of said at least three wind engaging rotor blades comprises a trough-shaped, vertical, wind engaging portion extending from an arm attached to said outer casing associated with said current inducing rotor, wherein said current inducing rotor comprises a circular array of permanent magnets, and wherein said current generating stator comprises a circular array of wound coils, and wherein said circular array of permanent magnets extends around a circumference of said stator and is rotatably attached thereto, thereby avoiding a torsional force on said cylindrical pole when said at least three wind-engaging rotor blades attached to said outer casing associated with said current inducing rotor begin to move; and
producing electricity using said current inducing rotor, said stationary, current generating stator, and said at least three wind-engaging rotor blades.

5. The method of claim 4 wherein the produced electricity is stored in a battery.

6. The method of claim 4 wherein the produced electricity is used in an electrical device.

7. A wind turbine mountable at or near an upper exterior portion of a stationary cylindrical pole, said wind turbine comprising:
a current inducing rotor comprising a current inducing set of permanent magnets rotatable about said upper exterior portion of said cylindrical pole, about an axis at least substantially in line with a main axis of said cylindrical pole;
a stationary, current generating stator comprising at least one wound coil about which said current inducing rotor rotates, wherein said current inducing rotor generates a magnetic field which passes in close proximity to said at least one wound coil; and
at least three wind-engaging rotor blades extending vertically from an outer casing associated with said current inducing rotor, wherein each of said at least three wind-engaging blades are movable upon application thereto of a prevailing wind, and wherein said at least three wind engaging rotor blades are vertically offset from one another, and wherein each of said at least three wind engaging rotor blades comprises a trough-shaped, vertical, wind engaging portion extending from an arm attached to said outer casing associated with said current inducing rotor,
wherein said current generating stator comprises a horizontally disposed circular array of wound coils, and wherein said current inducing rotor comprises a horizontally disposed circular array of permanent magnets positioned above, and in close proximity to said circular array of wound coils, and wherein said circular array of wound coils extends around a circumference of said cylindrical pole and is rigidly attached thereto, and wherein said circular array of permanent magnets extends around a circumference of said cylindrical pole and is rotatably attached thereto, thereby avoiding a torsional force on said cylindrical pole when said at least three wind-engaging rotor blades attached to said outer casing associated with said current inducing rotor begin to move.

8. The wind turbine of claim 7, wherein said at least three wind-engaging rotor blades are removably mounted to a top surface of said current inducing rotor with rotational symmetry about said current inducing rotor.

9. The wind turbine of claim 8, wherein the number of wind-engaging rotor blades is four.

10. The wind turbine of claim 7 wherein a plurality of said horizontally disposed circular arrays of wound coils are layered above and in close proximity to a plurality of said horizontally disposed circular arrays of permanent magnets and said at least three rotor blades are removably attached to a top surface of an uppermost circular array of permanent magnets.

11. A method comprising:
providing a current inducing rotor comprising a current inducing set of permanent magnets rotatable about said upper exterior portion of said cylindrical pole, about an axis at least substantially in line with a main axis of said cylindrical pole;
providing a stationary, current generating stator comprising at least one wound coil about which said current inducing rotor rotates, wherein said current inducing rotor generates a magnetic field which passes in close proximity to said at least one wound coil; and
providing at least three wind-engaging rotor blades extending vertically from an outer casing associated with said current inducing rotor, wherein each of said at least three wind-engaging blades are movable upon application thereto of a prevailing wind, and wherein said at least three wind engaging rotor blades are vertically offset from one another, and wherein each of said at least three wind engaging rotor blades comprises a trough-shaped, vertical, wind engaging portion extending from an arm attached to said outer casing associated with said current inducing rotor, wherein said current generating stator comprises a horizontally disposed circular array of wound coils, and wherein said current inducing rotor comprises a horizontally disposed circular array of permanent magnets positioned above, and in close proximity to said circular array of wound coils, and wherein said circular array of wound coils extends around a circumference of said cylindrical pole and is rigidly attached thereto, and wherein said circular array of permanent magnets extends around a circumference of said cylindrical pole and is rotatably attached thereto, thereby avoiding a torsional force on said cylindrical pole when said at least three wind-engaging rotor blades attached to said outer casing associated with said current inducing rotor begin to move; and
producing electricity using said current inducing rotor, said stationary, current generating stator, and said at least three wind-engaging rotor blades.

12. The method of claim 11 wherein the produced electricity is stored in a battery.

13. The method of claim 11 wherein the produced electricity is used in an electrical device.
